(19) United States
(12) Patent Application Publication
(10) Pub. No.: US 2014/0339029 A1
(43) Pub. Date: Nov. 20, 2014

(54) MAGNETIC FUNCTIONAL FLUID, DAMPER AND CLUTCH USING MAGNETIC FUNCTIONAL FLUID

(71) Applicants: Nagoya Institute of Technology, Aichi (JP); Dowa Electronics Materials Co., Ltd., Tokyo (JP)

(72) Inventors: Yasushi IDO, Aichi (JP); Koichi HAYASHI, Aichi (JP); Takayuki YOSHIDA, Tokyo (JP)

(73) Assignees: DOWA ELECTRONICS MATERIALS CO., LTD., Tokyo (JP); NAGOYA INSTITUTE OF TECHNOLOGY, Aichi (JP)

(21) Appl. No.: 14/277,277

(22) Filed: May 14, 2014

(30) Foreign Application Priority Data
May 17, 2013 (JP) 2013-105357

(51) Int. Cl. F16F 9/53; F16D 29/00

(52) U.S. Cl. CPC F16F 9/535; F16D 29/00
USPC 188/267.2; 252/62.51 R; 192/21.5

(57) ABSTRACT

Magnetic functional fluid includes dispersion medium; and dispersed particles which are dispersed in the dispersion medium, wherein the dispersed particles includes: first ferromagnetic particles having an average particle diameter of 0.5 μm to 50 μm; and second ferromagnetic particles each having a needle-like shape, each having a smaller particle size than the first ferromagnetic particles, and each having a length ratio of a long axis to a short axis of 2 or more.

### CROSS REFERENCE TO RELATED APPLICATION

This application is based on and incorporates herein by reference Japanese patent applications No. 2013-105357 filed on May 17, 2013.

### TECHNICAL FIELD

The present invention relates to a magnetic functional fluid and to a damper or a clutch using the magnetic functional fluid.

### BACKGROUND ART

A magnetic functional fluid is a functional fluid that responds to a magnetic field. As this type of magnetic functional fluid, there is, for example, a magnetorheological (MR) fluid in which micron-sized ferromagnetic particles are dispersed in a dispersion medium, such as oil, as disclosed in NPL 1. This is formed by ferromagnetic particles that have a large particle diameter, namely, by dispersed particles that are all micron-sized. The ferromagnetic particles have a multi-magnetic-domain structure. Then, it is known that the MR fluid shows Bingham fluid-like viscous properties, which show yield stress.

Further, in addition to the above, there is a magnetic functional fluid as disclosed in PTL 1. In PTL 1, ferromagnetic particles having a large particle diameter of 0.5 μm to 50 μm and ferromagnetic particles having a small particle diameter equal to or less than 25 nm are both dispersed, as dispersed particles, in a dispersion medium that has electrical insulation properties, such as kerosene or silicone oil. Both the large particle diameter ferromagnetic particles and the small particle diameter ferromagnetic particles are sphere shaped, and the small particle diameter ferromagnetic particles have a single magnetic domain structure, since the particle diameter is equal to or smaller than 25 nm.

PTL1: Japanese Patent Application Publication No. JP-A-2002-170791

NPL 1: “Magnetic Fluids”, Hiroshi Yamaguchi, MORIKITA PUBLISHING Co. Ltd., 2011.

### SUMMARY OF THE INVENTION

At present, as a vibration control device that uses a magnetic functional fluid, a damper that uses the above-described MR fluid is commercially available. This damper is a damper that uses the viscosity of the fluid, and can increase the damping force of the damper by increasing the viscosity of the fluid.

There are methods to increase the viscosity of the above-described MR fluid, such as causing the volumetric proportion of the dispersed particles to increase or increasing the diameter of the dispersed particles. However, there is a limit to the volumetric proportion of the ferromagnetic particles that can be mixed into a dispersion medium, and it is known that if this limit is exceeded, the fluid ceases to function as a fluid. Further, if the diameter of the particles is increased, dispersion stability of the particles deteriorates and the particles settle.

This problem can be said to similarly apply to the magnetic functional fluid of the above-described PTL 1. In particular, in the magnetic functional fluid of the above-described PTL 1, instead of the fluid in which the dispersed particles are all the ferromagnetic particles having the large particle diameter, the fluid is formed by replacing some of the large particle diameter ferromagnetic particles with ferromagnetic particles that have a small particle diameter. When a comparison is made between the fluid of PTL 1 and the fluid in which the dispersed particles are all the ferromagnetic particles having the large particle diameter, when a volume concentration of the dispersed particles is the same, the viscosity becomes smaller the greater the amount of replacement particles.

In light of the foregoing, it is an object of the present invention to provide a magnetic functional fluid in which a greater degree of viscosity is possible than the above-described known magnetic functional fluid when a comparison is made with a same volumetric concentration of dispersed particles. Further, it is another object of the present invention to provide a damper and a clutch that use this type of the magnetic functional fluid.

In order to achieve the above-described object, according to a first aspect of the present invention, magnetic functional fluid includes dispersion medium; and dispersed particles which are dispersed in the dispersion medium, wherein the dispersed particles includes: first ferromagnetic particles having an average particle diameter of 0.5 μm to 50 μm; and second ferromagnetic particles each having a needle-like shape, each having a smaller particle size than the first ferromagnetic particles, and each having a length ratio of a long axis to a short axis of 2 or more.

Similarly to the magnetic functional fluid of the above-described PTL 1, the magnetic functional fluid according to the first aspect is a fluid formed, in contrast to a fluid in which all of the dispersed particles are ferromagnetic particles having a large particle diameter, by replacing some of the ferromagnetic particles having the large particle diameter with ferromagnetic particles having a smaller particle diameter. However, the magnetic functional fluid according to the first aspect is different to the magnetic functional fluid of PTL 1 in that, when a comparison is made with the fluid in which the dispersed particles are all the ferromagnetic particles having the large particle diameter and when the volumetric concentration of the dispersed particles is the same, the viscosity increases the greater the amount of replaced particles.

Therefore, according to the first aspect of the present invention, it is possible to provide a magnetic functional fluid in which a greater degree of viscosity is possible than in the above-described known MR fluid and the magnetic functional fluid of PTL 1.

In the magnetic functional fluid according to a second aspect, the second ferromagnetic particles have an average particle diameter of 50 nm to 300 nm.. Further, the magnetic functional fluid according to a third aspect has properties that are different to those of the known magnetic functional fluid. As described in a third aspect, the magnetic functional fluid has Bingham fluid-like viscous properties when a magnetic field is not applied and has pseudoplastic fluid-like viscous properties when a magnetic field is applied.

According to a fourth aspect of the present invention, a damper using viscous resistance of working fluid includes: the magnetic functional fluid according to one of claim 1 which serves as the working fluid; and magnetic field application device which applies magnetic field to the working fluid.

According to a fifth aspect of the present invention, a clutch for transmitting rotation of an input shaft to an output shaft via working fluid includes: the magnetic functional fluid according to one of claim 1 which serves as the working fluid; and magnetic field application device for applying magnetic field to the working fluid.

According to the fourth and fifth aspect of the present invention, a damper and a clutch are provided that use the viscous properties of the magnetic functional fluid according to the first to third aspects.

### BRIEF DESCRIPTION OF DRAWINGS

FIG. 1A is a schematic diagram showing dispersed particles in a magnetic functional fluid of the present invention.

FIG. 1B is a schematic diagram showing dispersed particles in a magnetic functional fluid of the present invention.

FIG. 2 is a cross-sectional view showing a structure of a damper according to a first embodiment.

FIG. 3 is a cross-sectional view showing a structure of a damper according to a second embodiment.

FIG. 4 is a cross-sectional view showing a structure of a clutch according to a third embodiment.

FIG. 5 is a diagram showing magnetic flux density distribution at a center position of an orifice portion of the damper used in working examples.

FIG. 6 is a diagram showing relationships between piston speed and maximum damping force when there is no applied magnetic field, in the damper using a fluid 1 of a comparative example and fluids 2 to 5 of the working examples.

FIG. 7 is a diagram showing relationships between the piston speed and the maximum damping force when there is an applied magnetic field, in the damper using the fluid 1 of the comparative example and the fluids 2 to 5 of the working examples.

FIG. 8 is a diagram illustrating general tendencies that classify a fluid based on viscous properties.

FIG. 9A is a diagram showing damping force—displacement curves of the damper using the fluid 1 of the comparative example and the fluids 2 to 5 of the working examples in a case that there is no applied magnetic field and that an vibration frequency is 2 Hz.

FIG. 9B is a diagram showing damping force—displacement curves of the damper using the fluid 1 of the comparative example and the fluids 2 to 5 of the working examples in a case that there is an applied magnetic field and that an vibration frequency is 2 Hz.

FIG. 10A is a diagram showing damping force—displacement curves of the damper using the fluid 1 of the comparative example and the fluids 2 to 5 of the working examples in a case that there is no applied magnetic field and that an vibration frequency is 10 Hz.

FIG. 10B is a diagram showing damping force—displacement curves of the damper using the fluid 1 of the comparative example and the fluids 2 to 5 of the working examples in a case that there is an applied magnetic field and that an vibration frequency is 10 Hz.

FIG. 11A is a diagram showing damping force—displacement curves of the damper using fluids 6 to 8 of comparative examples in a case that case in which there is no applied magnetic field and that an vibration frequency is 2 Hz.

FIG. 11B is a diagram showing damping force—displacement curves of the damper using fluids 6 to 8 of comparative examples in a case that case in which there is an applied magnetic field and that an vibration frequency is 2 Hz.

FIG. 12A is a diagram showing damping force—displacement curves of the damper using the fluid 1 of the comparative example and fluids 9 and 10 of working examples in a case that there is no applied magnetic field and that an vibration frequency is 2 Hz.

FIG. 12B is a diagram showing damping force—displacement curves of the damper using the fluid 1 of the comparative example and fluids 9 and 10 of working examples in a case that there is an applied magnetic field and that an vibration frequency is 2 Hz.

FIG. 13A is a diagram showing damping force—displacement curves of the damper using the fluid 1 of the comparative example and the fluids 9 and 10 of the working examples in a case that there is no applied magnetic field and that an vibration frequency is 10 Hz.

FIG. 13B is a diagram showing damping force—displacement curves of the damper using the fluid 1 of the comparative example and the fluids 9 and 10 of the working examples in a case that there is an applied magnetic field and that an vibration frequency is 10 Hz.

### DESCRIPTION OF EMBODIMENTS

Hereinafter, embodiments of the present invention will be explained based on the drawings. Note that in each of the following embodiments, portions that are the same or equivalent to each other are explained using the same reference numeral.

### First Embodiment

### (Composition of Magnetic Functional Fluid)

The magnetic functional fluid of the present invention is a fluid in which, as dispersed particles (i.e. dispersoid), first ferromagnetic particles and needle-shaped second ferromagnetic particles are dispersed in a dispersion medium. Each of the second ferromagnetic particles has a needle-like shape. The particle diameter (particle size) of the second ferromagnetic particles is smaller than that of the first ferromagnetic particles.

An organic base oil, such as polyalphaolefin, is used as the dispersion medium. The dispersion medium is not limited to the organic base oil, and water or another dispersion medium may be used, as long as the effects of the present invention are obtained.

The first ferromagnetic particles are micron-sized particles, that is, they are particles having an average particle diameter (average particle size) of 0.5 μm to 50 μm. This is because particles having a particle diameter that is large to a certain extent are used as the first ferromagnetic particles and particles having a particle diameter (particle size) larger than 50 μm are likely to settle. The shape of the first ferromagnetic particles is, for example, spherical. The material of the first ferromagnetic particles is a material that shows ferromagnetic properties and is, for example, Fe, Co, Ni or an alloy that is formed from two or more of these elements.

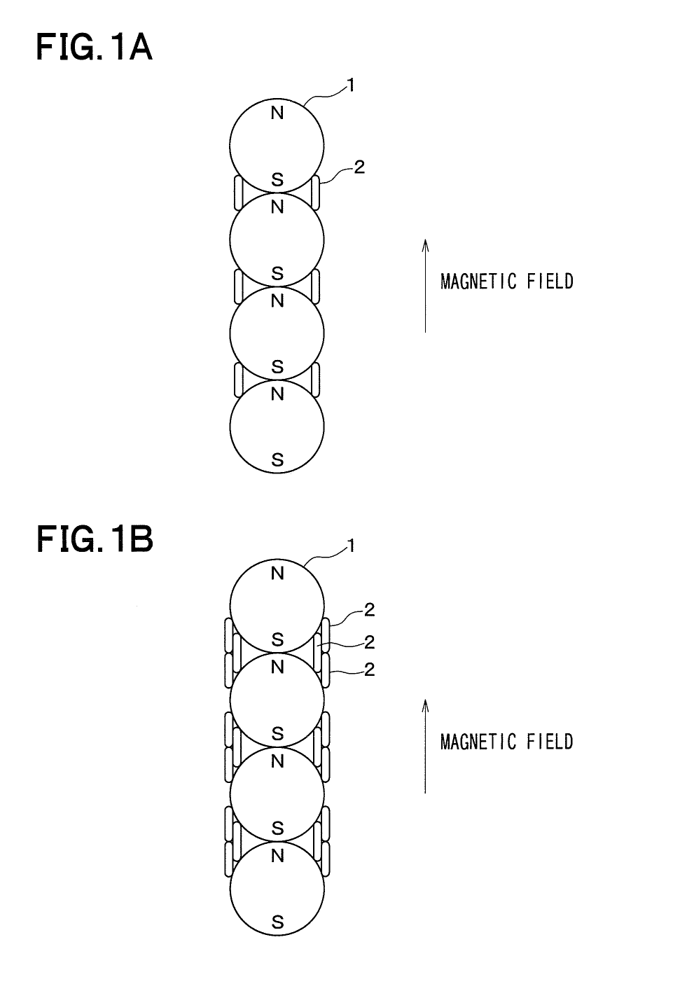

The second ferromagnetic particles have a smaller particle diameter than the first ferromagnetic particles, and have a multi-magnetic domain structure or a single magnetic domain structure. For example, particles having an average particle diameter (an average particle diameter in a long axis direction) that is equal to or more than 50 nm and equal to or less than 300 nm are used. Note that as long as the particle diameter of the second ferromagnetic particles is smaller than that of the first ferromagnetic particles, the second ferromagnetic particles may be micron-sized. It is preferable that the size of the second ferromagnetic particles is a size that enters between adjacent first ferromagnetic particles in a chain cluster of the first ferromagnetic particles which is shown in FIG. 1A and which will be explained later. Examples of materials that can be used as the second ferromagnetic particles are materials that show similar ferromagnetic properties to the material of the first ferromagnetic particles. The second ferromagnetic particles are needle shaped and a length ratio of a long axis to a short axis is 2 or more. They have a same shape as that of two or more spherical ferromagnetic particles aligned in a cluster. When a steady magnetic field is applied to this type of second ferromagnetic particles, the second ferromagnetic particles have a magnetic moment in the long axis direction and the long axis is oriented in the magnetic field direction.

A volumetric proportion of the dispersed particles (the first and the second ferromagnetic particles) to the fluid as a whole is set within a range in which fluid-like properties are obtained, and can be set as 30 vol %, for example. Further, a volumetric proportion of the second ferromagnetic particles to the fluid as a whole is set in a range at which the second ferromagnetic particles can be added, and can be set as 2 to 10 vol %, for example.

One of a thickener, which suppresses particle settling, and a surfactant, such as oleic acid, which improves dispersibility, may be added to the magnetic functional fluid as necessary, or both the thickener and the surfactant may be added.

Here, as disclosed in PTL 1, it is known that the ferromagnetic particles in the dispersion medium have a magnetic moment when a magnetic field is applied, and the magnetic interaction force that acts between the particles causes the formation of chain clusters.

In contrast to this, when the needle shaped ferromagnetic particles are used as the dispersed particles, as in the present invention, the needle shaped ferromagnetic particles have the same shape as that of two or more spherical ferromagnetic particles aligned in a cluster. Thus, even in a state in which there is no magnetic field, there is a similar effect as with short chain clusters, and the viscosity of the fluid increases.

Further, as shown in FIG. 1A and FIG. 1B, when a magnetic field is applied to the magnetic functional fluid of the present invention, after first ferromagnetic particles 1 have formed a chain cluster, needle shaped second ferromagnetic particles 2 form a large cluster so as to reinforce the chain cluster. At that time, as shown in FIG. 1A, one of the second ferromagnetic particles 2 enters between the adjacent first ferromagnetic particles 1 such that the second ferromagnetic particle 2 forms a bridge between the adjacent first ferromagnetic particles 1 and thus integrates the first ferromagnetic particles 1. In addition to this, as shown in FIG. 1B, the second ferromagnetic particles 2 integrate together on the outside of the second ferromagnetic particle 2 that has entered between the adjacent first ferromagnetic particles 1. The internal structure of this type of fluid causes the viscosity of the fluid to increase.

As a result, it is thought that the magnetic functional fluid of the present invention has the following properties. Namely, in contrast to the fluid in which the dispersed particles are all the ferromagnetic particles having the large particle diameter, the magnetic functional fluid of the present invention is formed by replacing some of the ferromagnetic particles having the large particle diameter with the ferromagnetic particles having the small particle diameter, in a similar manner to the magnetic functional fluid of the above-mentioned PTL 1. When the volumetric proportion of the dispersed particles is taken as a constant and some of the micron-sized large ferromagnetic particles are replaced with the small-sized smaller ferromagnetic particles, in the magnetic functional fluid of the above-mentioned PTL 1, the viscosity decreases the greater the amount of replacement ferromagnetic particles whose diameter is equal to or less than 25 nm. In contrast to this, the magnetic functional fluid of the present invention has the property that the viscosity increases the greater the amount of the replacement ferromagnetic particles 2. In this manner, according to the magnetic functional fluid of the present invention, when a comparison is made when there is a same volumetric concentration of the dispersed particles, it is possible to increase the viscosity to a greater extent than the above-described known MR fluid and the magnetic functional fluid of the PTL 1.

Further, although a detailed reason is not clear at the present time, the magnetic functional fluid of the present invention has viscous properties similar to those of a pseudoplastic fluid when a magnetic field is applied, as well as viscous properties similar to those of a Bingham fluid when the magnetic field is not applied, due to the first and second ferromagnetic particles. This is explained in more detail later in a working example.

(Damper using Magnetic Functional Fluid)

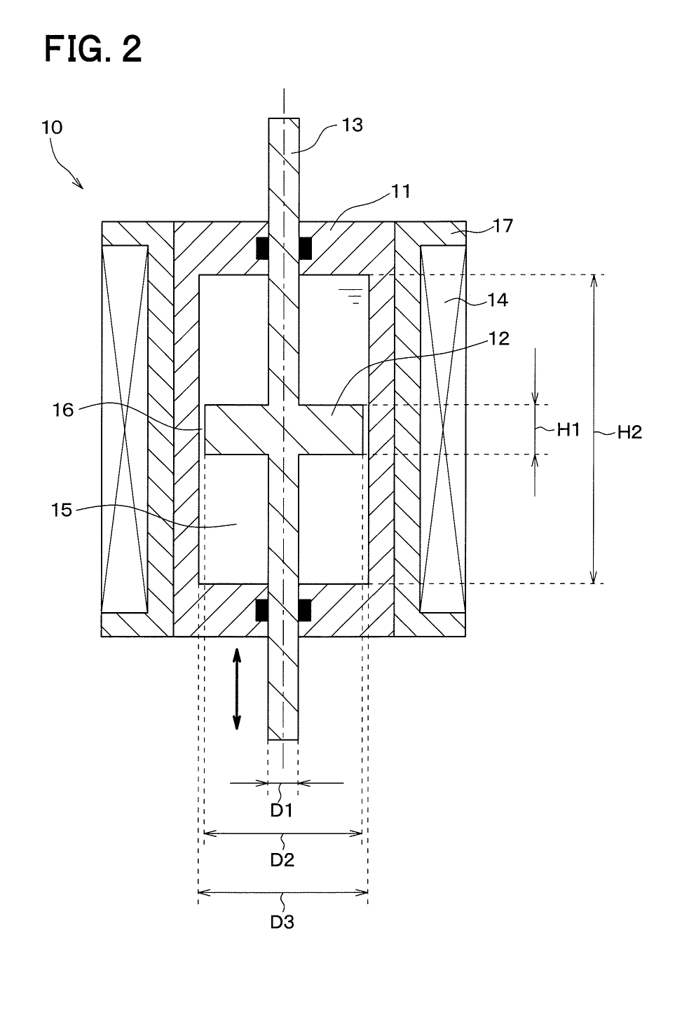

FIG. 2 shows a damper 10 that uses, as a working fluid 15, the magnetic functional fluid having the above-described composition. The damper 10 is a damper that uses the viscous resistance of the working fluid 15, and is provided with a cylinder 11, a piston 12, a shaft 13 and a coil 14.

The interior of the cylinder 11 is filled with the working fluid 15. An orifice portion 16 is formed between the outer peripheral portion of the piston 12 and the inner surface of the cylinder 11. A damping force is generated by the viscous resistance of the working fluid 15 that arises when the piston 12 that is fixed to the shaft 13 is moved. The coil 14 is magnetic field application means that applies a magnetic field to the working fluid 15. In the present embodiment, the coil 14 is wound around a bobbin 17 such that it covers the whole outer peripheral portion of the cylinder 11, and it is possible to apply a magnetic field to the working fluid 15 over the whole interior of the cylinder 11 by passing an electric current through the coil 14.

The damper 10 of the present embodiment uses the magnetic functional fluid having the above-described composition as the working fluid 15, and can thus change the damping force as a result of the magnetic field application, as explained in the working example below. Further, the damper 10 has damping force characteristics in which the damping force becomes small in the case of a low frequency domain and a small amplitude.

### Second Embodiment

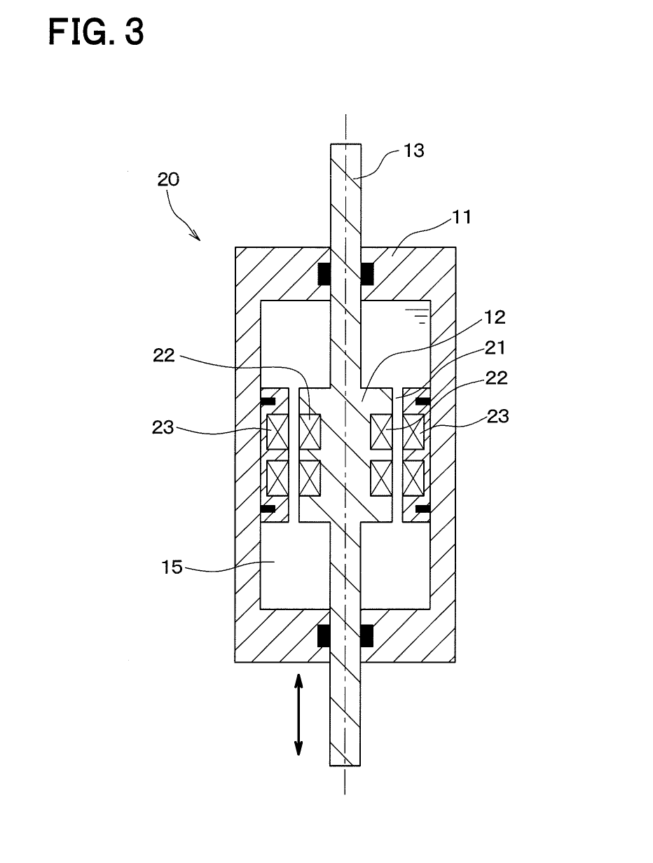

FIG. 3 shows a damper 20 of a present embodiment. The damper 20 of the present embodiment is different from the damper 10 of the first embodiment in that the orifice portion and the position of the coil are changed, and an orifice portion 21, an internal coil 22 and an outer coil 23 are provided in the interior of the piston 12. The damper 20 is a damper that can locally apply a magnetic field to a working fluid that passes through the orifice portion 21. This type of the damper 20 also has the same damping force characteristics of the damper 10 of the first embodiment.

### Third Embodiment

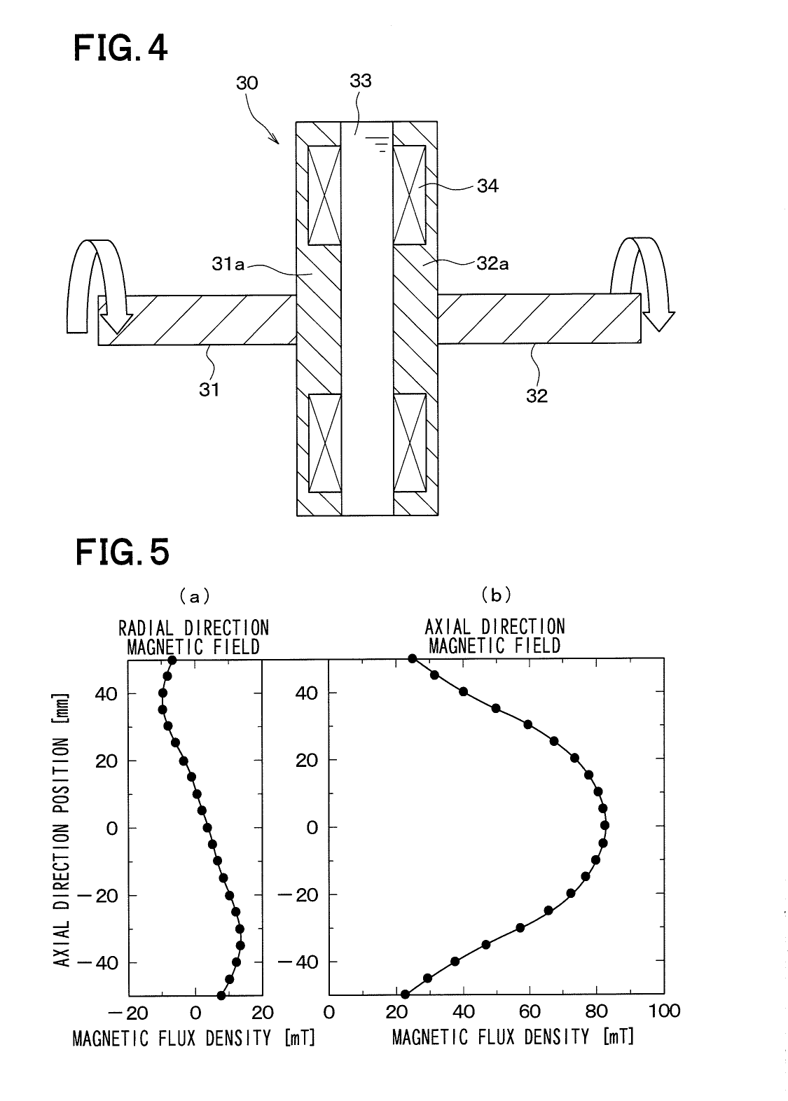

FIG. 4 shows a schematic configuration of a clutch 30 that uses the magnetic functional fluid of the present invention. The clutch 30 is a clutch that transmits a rotation of an input shaft 31 to an output shaft 32 via a working fluid 33. A leading end plate portion 31a of the input shaft 31 opposes a leading end plate portion 32a of the output portion 32, and the working fluid 33 is disposed between both of the leading end plate portions 31a and 32a that oppose each other. Coils 34, which are magnetic field application means for applying a magnetic field to the working fluid 33, are provided on both the leading end plate portions 31a and 32a.

The magnetic functional fluid of the present invention has viscous properties similar to those of a pseudoplastic fluid when a magnetic field is applied, namely, it has viscous properties in which viscosity in a low-speed area becomes rapidly lower when the magnetic field is applied, as in the explanation of the working example below. Thus, the clutch 30 of the present embodiment has a property by which the torque transmitted to the output shaft 32 becomes rapidly lower in line with a reduction in rotation speed of the input shaft 31. In other words, the clutch 30 has a property by which a transmission rate rapidly decreases in the low-speed area.

### WORKING EXAMPLES

### (Experiment 1)

Each of working fluids having respective compositions shown in a Table 1 were prepared and used as the working fluid 15 in the damper 10 shown in FIG. 2 that is explained in the first embodiment, and the damping force of the damper 10 was measured. It should be noted that each of the dimensions shown in FIG. 2 of the damper 10 used are as follows. A piston height H1=10 mm, a cylinder inner side height H2=60 mm, a shaft diameter D1=6 mm, a piston diameter D2=31 mm and a cylinder inner diameter D3=33 mm.

TABLE 1

| | | μm SIZED | NEEDLE SHAPED | | | |
|---|---|---|---|---|---|---|
| | | FERROMAGNETIC | FERROMAGNETIC | DISPERSION | | |
| | FLUID | PARTICLES | PARTICLES | MEDIUM | THICKENER | SURFACTANT |
| | NUMBER | [vol. %] | [vol. %] | [vol. %] | [vol. %] | [vol. %] |
| COMPARATIVE | FLUID1 | 30 | 0 | 67.23 | 2.21 | 0.551 |
| EXAMPLE | | | | | | |
| WORKING | FLUID2 | 28 | 2 | 66.05 | 2.17 | 1.77 |
| EXAMPLE | FLUID3 | 26 | 4 | 64.87 | 2.14 | 2.99 |
| | FLUID4 | 24 | 6 | 63.68 | 2.10 | 4.22 |
| | FLUID5 | 22 | 8 | 62.50 | 2.06 | 5.44 |

In Table 1, a fluid 1 is a comparative example that corresponds to the known MR fluid. Fluids 2 to 5 are working examples of the present invention. The μm sized ferromagnetic particles listed in Table 1 are the first ferromagnetic particles and the needle shaped ferromagnetic particles are the second ferromagnetic particles. For each of the fluids, the volumetric proportion of the dispersed particles is constant at 30 vol % and each of the fluids uses the first ferromagnetic particles having an average particle diameter of 1.2 μm and the second ferromagnetic particles having an average particle diameter of 100 nm and an average of 4 as the length ratio of the long axis to the short axis. However, a mixture ratio of the first and second ferromagnetic particles is changed for each of the fluids. The first and second ferromagnetic particles are both formed of iron powder, and a magnetic powder that is generally used as the magnetic powder of a magnetic tape was used as the second ferromagnetic particles. Further, polyalphaolefin was used as a dispersion agent, smectite was used as a thickener and oleic acid was used as a surfactant.

Then, the damping force was measured when the piston 12 was forcibly oscillated at each of constant frequencies (1 to 10 Hz) with an amplitude of ±4 mm. At that time, both a case in which there was no applied magnetic field and a case in which there was an applied magnetic field were measured. (a) and (b) in FIG. 5 show magnetic flux density distribution in a radial direction and an axial direction at a central position of the orifice portion 16 when there is an applied magnetic field. The axial direction position takes a central position of the cylinder 11 as 0.

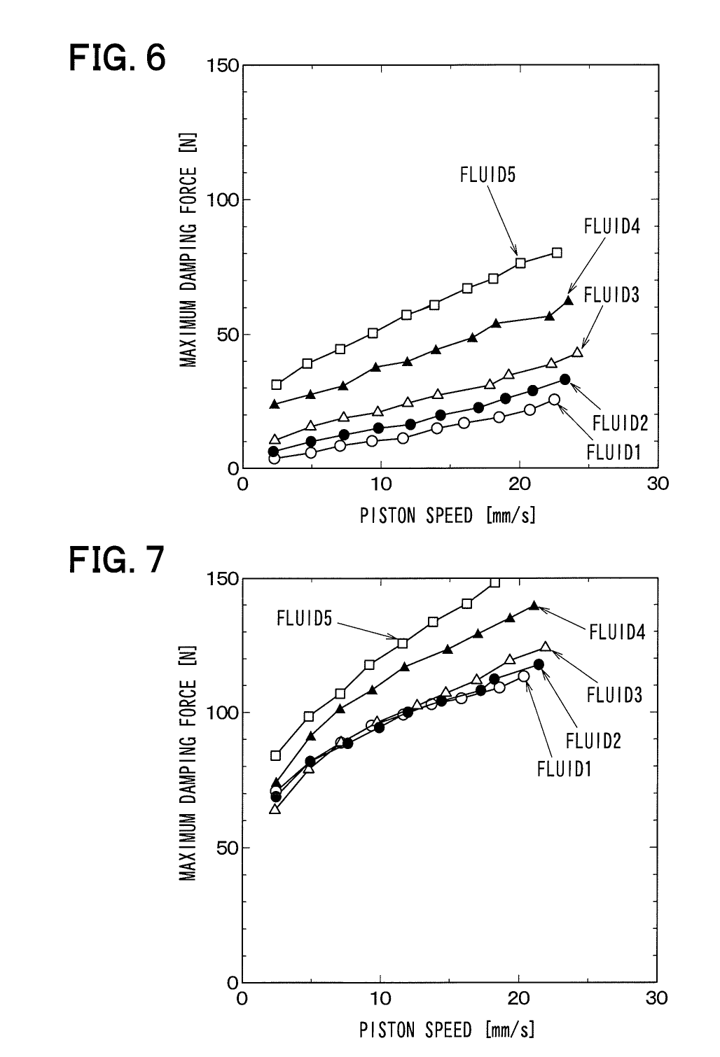

FIG. 6 and FIG. 7 show relationships between piston speed and maximum damping force. Maximum damping force characteristics were obtained as shown in FIG. 6 and FIG. 7. FIG. 6 shows results when the magnetic field is not applied and it can be seen that for all of the fluids, the maximum damping force increases in almost direct proportion with the piston speed. Moreover, it can be seen that if the ratio of the second ferromagnetic particles in the constant volumetric proportion of the dispersed particles increases, the maximum damping force also increases. FIG. 7 shows the relationship between the piston speed and the maximum damping force when the magnetic field is applied. From FIG. 7, it can be seen that in the case of all of the fluids, there is a greater increase in the maximum damping force than in the case when there is no magnetic field. Further, in the case of the fluids 2 to 5 that are the functional fluids of the present invention, it is clear that there is a tendency for the maximum damping force to reduce rapidly when the piston speed becomes slower.

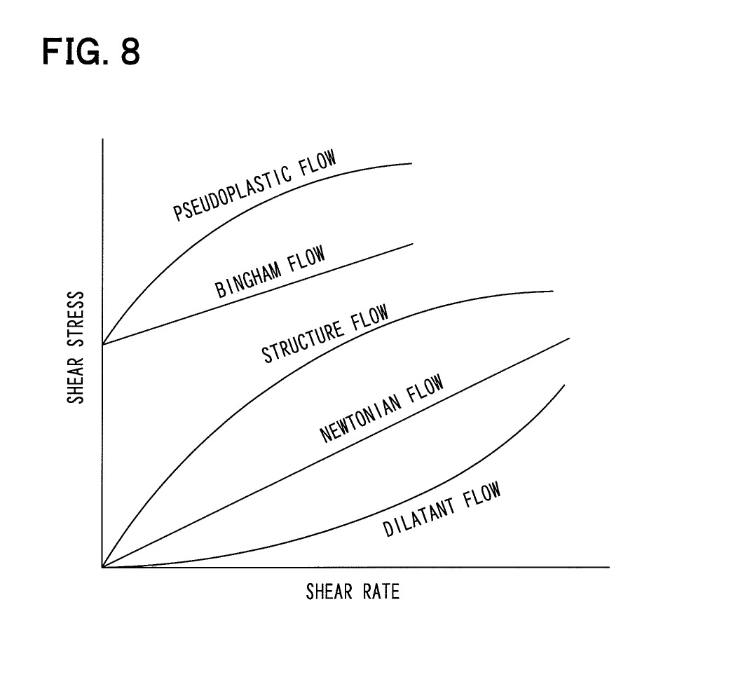

From the above, as can be seen with reference to FIG. 8, it is clear that the magnetic functional fluid of the present invention has viscous properties like those of a Bingham fluid when there is no magnetic field, and has viscous properties like those of a pseudoplastic fluid when the magnetic field is applied. These properties are not observed in the known magnetic functional fluids.

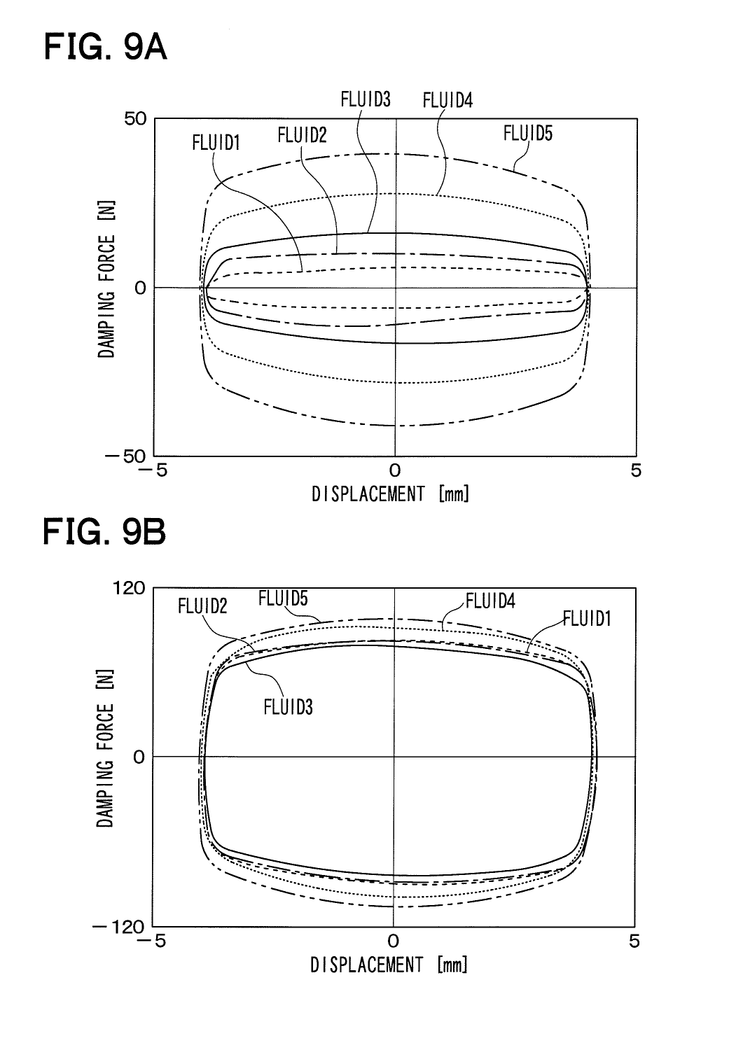

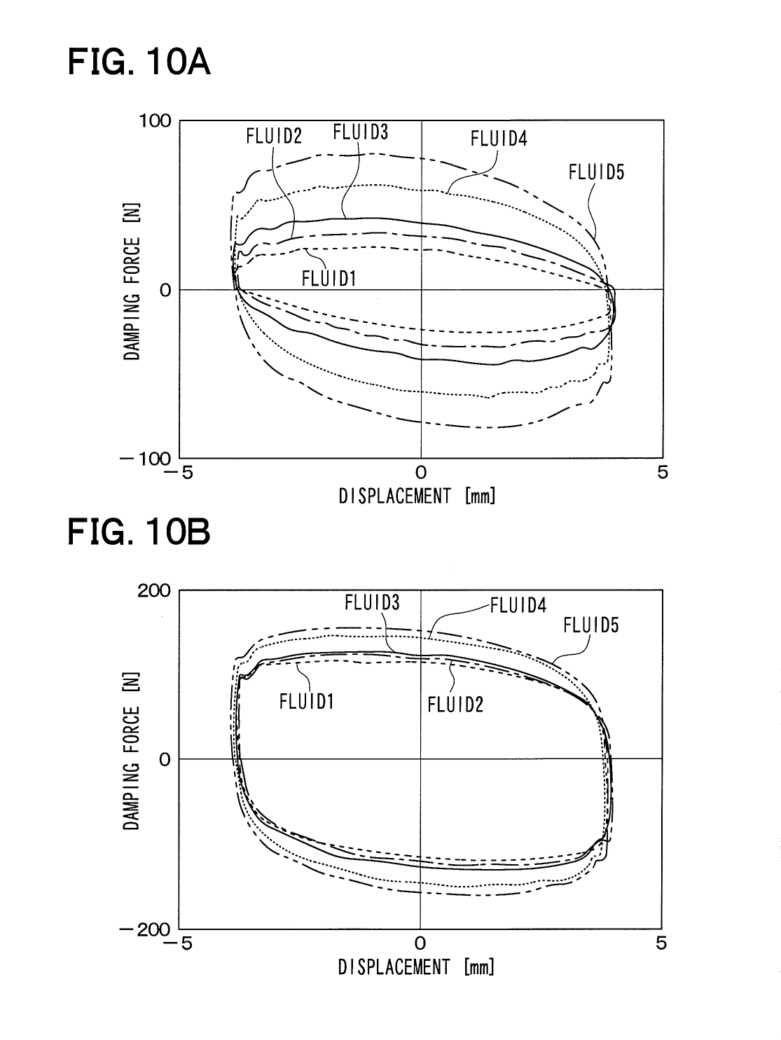

Further, FIGS. 9A, 9B and FIGS. 10A, 10B show damping force—displacement curves. FIGS. 9A, 9B show a case in which an vibration frequency is 2 Hz and FIGS. 10A, 10B show a case in which an vibration frequency is 10 Hz. FIG. 9A and FIG. 10A show a case in which there is no applied magnetic field and FIG. 9B and FIG. 10B show a case in which there is an applied magnetic field.

From FIG. 9A and FIG. 10A, it can be seen that, in both cases, the damping force becomes larger the greater the volumetric proportion of the second ferromagnetic particles when there is no applied magnetic field. On the other hand, as shown in FIG. 9B and FIG. 10B, a similar tendency can also be observed when the magnetic field is applied. However in the case of a low frequency, such as 2 Hz, the piston speed enters a low speed area and, due to the pseudoplastic fluid-like viscous properties, when the volumetric proportion of the second ferromagnetic particles is low (as in the fluids 2 and 3), the damping force does not significantly increase.

In order to compare the above results with the magnetic functional fluid disclosed in PTL 1, three types of fluid having compositions shown in a Table 2 were prepared (fluids 6, 7 and 8 that are comparative examples). The fluids 6, 7 and 8 have the same volumetric proportion of dispersed particles as in the case of the fluids shown in Table 1, namely 30 vol %, but the volumetric proportion of the μm sized ferromagnetic particles and the 10 nm sized ferromagnetic particles has been changed. Note that the dispersion medium used is the same as the fluids shown in Table 1.

TABLE 2

| | | μm SIZED | 10 μm SIZED | DISPERSION | |
|---|---|---|---|---|---|
| | | FERROMAGNETIC | FERROMAGNETIC | MEDIUM + | |
| | FLUID | PARTICLES | PARTICLES | SURFACTANT | THICKENER |
| | NUMBER | [vol. %] | [vol. %] | [vol. %] | [vol. %] |
| COMPARATIVE | FLUID6 | 30 | 0 | 67.9 | 2.1 |
| EXAMPLE | FLUID7 | 28 | 2 | 67.9 | 2.1 |
| | FLUID8 | 26 | 4 | 67.9 | 2.1 |

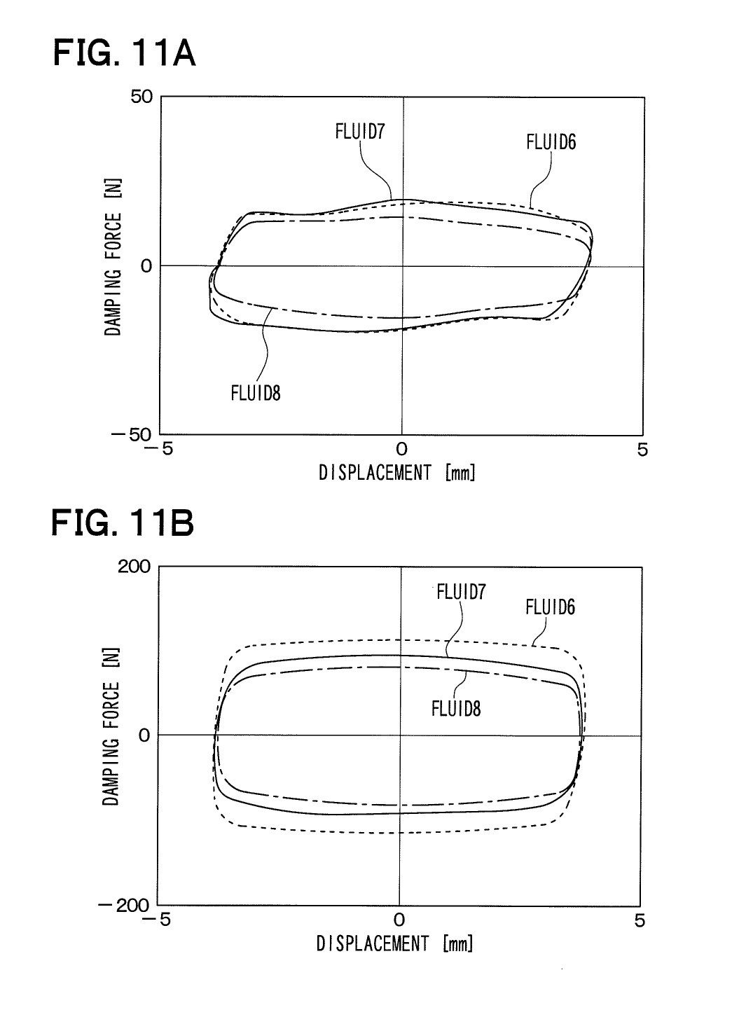

Then, the fluids 6 to 8 were used as the working fluid 15 in the damper 10 shown in FIG. 2, and, when the damping force—displacement curves were calculated, they were as shown in FIGS. 11A, 11B. FIGS. 11A, 11B are diagrams in which forcible vibration frequency is 2 Hz, and FIG. 11A shows a case in which there is no applied magnetic field, and FIG. 11B shows a case in which there is an applied magnetic field. From FIGS. 11A, 11B it is clear that, in the cases of the fluids 6 to 8, if the volumetric proportion of the 10 nm sized ferromagnetic particles is increased, the damping force decreases.

From the above results of the experiments, it was confirmed that the magnetic functional fluid of the present invention has completely reverse properties to those of the magnetic functional fluid disclosed in PTL 1.

### (Experiment 2)

Fluids 9 and 10 that are shown in a Table 3 were prepared and an experiment was performed in the same manner as Experiment 1. The μm sized particles listed in Table 3 are the first ferromagnetic particles and the needle shaped ferromagnetic particles are the second ferromagnetic particles. The second ferromagnetic particles used are particles having an average particle diameter of 150 nm, and the length ratio of the long axis to the short axis is in a range between 5 and 10. The other materials used were the same as those in Experiment 1. The fluids 9 and 10 are working examples of the present invention, and the mixture ratio of the first and second ferromagnetic particles is the same as that of the fluids 3 and 5 of Table 1.

TABLE 3

| | | μm SIZED | NEEDLE SHAPED | | | |
|---|---|---|---|---|---|---|
| | | FERROMAGNETIC | FERROMAGNETIC | DISPERSION | | |
| | FLUID | PARTICLES | PARTICLES | MEDIUM | THICKENER | SURFACTANT |
| | NUMBER | [vol. %] | [vol. %] | [vol. %] | [vol. %] | [vol. %] |
| WORKING | FLUID9 | 26 | 4 | 62.50 | 2.06 | 5.44 |
| EXAMPLE | FLUID10 | 22 | 8 | 62.50 | 2.06 | 5.44 |

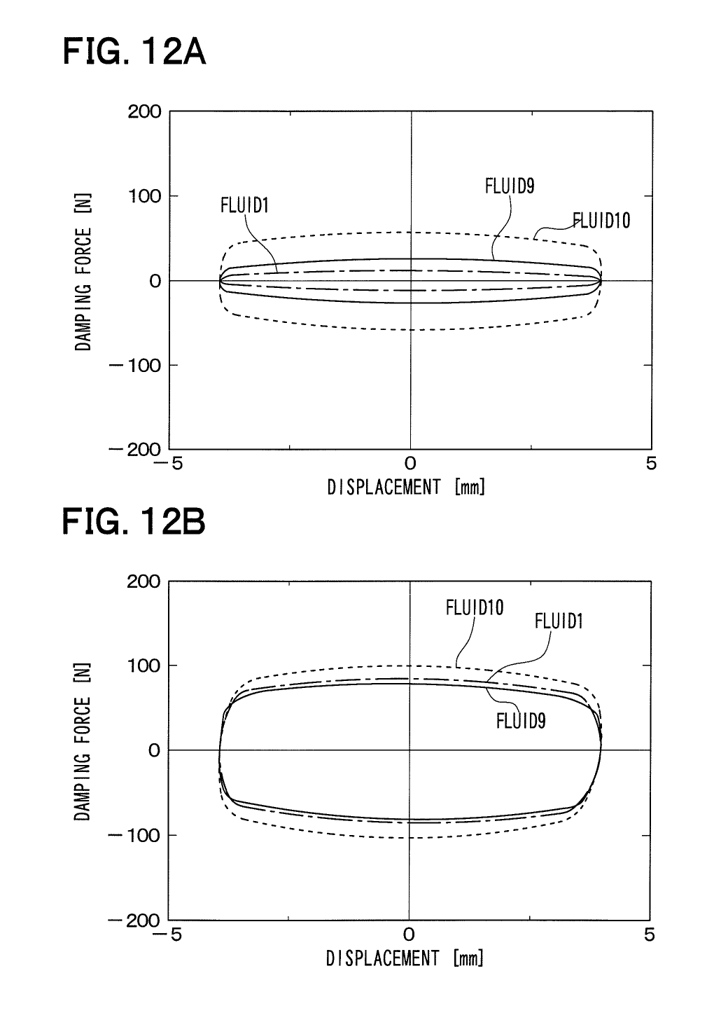

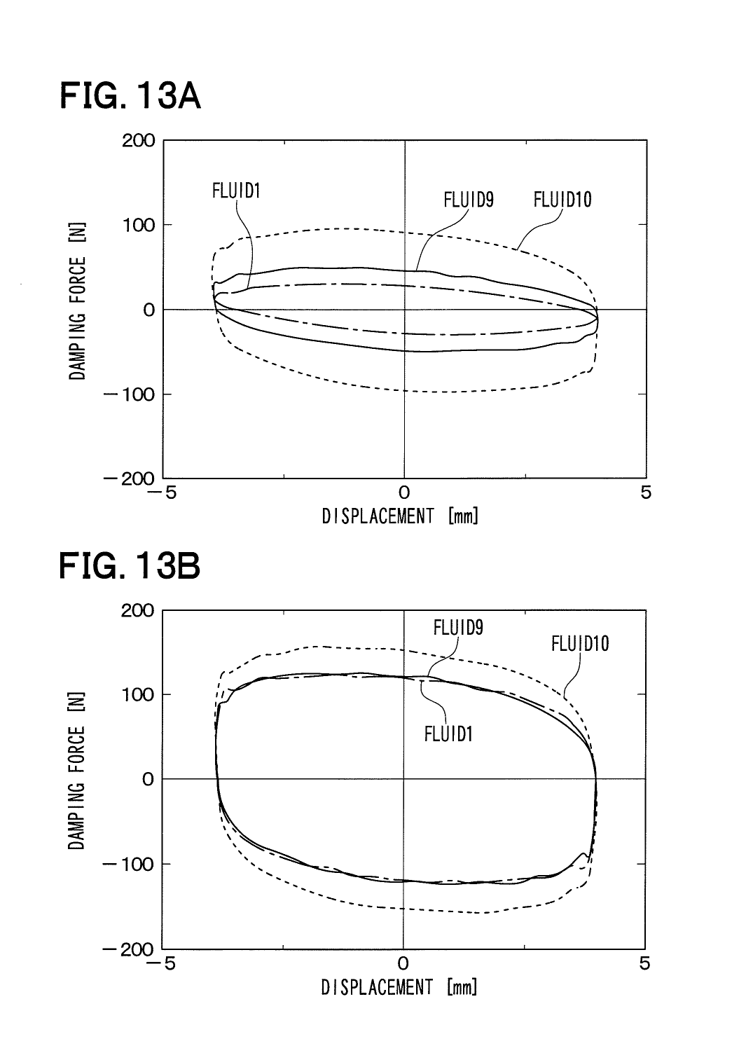

The results obtained were the same as the results of Experiment 1, as shown in FIGS. 12A, 12B and FIGS. 13A, 13B. FIGS. 12A, 12B and FIGS. 13A, 13B are damping force—displacement curves, and are diagrams of cases when the vibration frequency is 2 Hz and 10 Hz. Note that, in FIGS. 12A, 12B and FIGS. 13A, 13B, results of fluid 1 that is the comparative example are also shown. FIG. 12A and FIG. 13A show cases in which there is no applied magnetic field and FIG. 12B and FIG. 13B show cases in which there is an applied magnetic field.

As shown in FIG. 12A and FIG. 13A, when there is no applied magnetic field, the larger the volumetric proportion of the second ferromagnetic particles, the larger the damping force. On the other hand, as shown in FIG. 12B and FIG. 13B, when the magnetic field is applied, when the volumetric proportion of the second ferromagnetic particles is 8% (fluid 10), the damping force is notably large. However, it can be seen that when the volumetric proportion of the second ferromagnetic particles is approximately 4% (fluid 9), there is almost no difference to the fluid that does not contain the second ferromagnetic particles (fluid 1). These type of results could be obtained because, although the piston speed and the maximum damping force are almost directly proportional when there is no magnetic field applied, under the application of the magnetic field, as the forcible vibration frequency becomes lower, the maximum damping force suddenly decreases.

It should be noted that the present invention is not limited to the above-described embodiments and working examples and various modifications are possible without departing from the scope of the claims. Further, in each of the above-described embodiments, it goes without saying that the elements that form the embodiments are not necessarily essential, apart from a case in which it is particularly stated that they are essential and in which it is thought that they are clearly essential in principle. In addition, in each of the above-described embodiments, it goes without saying that the number, value, amount and range etc. of the structural elements of the embodiments are not limited to the number specified herein, apart from a case in which it is particularly stated that they are essential and in which they are clearly limited to a particular number in principle. Furthermore, in each of the above-described embodiments, when a shape or a positional relationship etc. of a structural element is mentioned, the shape and the positional relationship etc. is not limited, apart from a case in which the shape and the positional relationship etc. is clearly stated and in which the shape and the positional relationship etc. are limited to a particular shape and positional relationship in principle.

1. Magnetic functional fluid comprising:
dispersion medium; and
dispersed particles which are dispersed in the dispersion medium,
wherein the dispersed particles includes:
first ferromagnetic particles having an average particle diameter of 0.5 μm to 50 μm; and
second ferromagnetic particles each having a needle-like shape, each having a smaller particle size than the first ferromagnetic particles, and each having a length ratio of a long axis to a short axis of 2 or more.

2. The magnetic functional fluid according to claim 1, wherein the second ferromagnetic particles have an average particle diameter of 50 nm to 300 nm.

3. The magnetic functional fluid according to claim 1, wherein due to the first and second ferromagnetic particles, the magnetic functional fluid has Bingham fluid-like viscous properties when a magnetic field is not applied and has pseudoplastic fluid-like viscous properties when a magnetic field is applied.

4. A damper using viscous resistance of working fluid, comprising:
the magnetic functional fluid according to claim 1 which serves as the working fluid; and
magnetic field application device which applies magnetic field to the working fluid.

5. A clutch for transmitting rotation of an input shaft to an output shaft via working fluid, comprising:
the magnetic functional fluid according to claim 1 which serves as the working fluid; and
magnetic field application device for applying magnetic field to the working fluid.
